(19) United States
(12) Patent Application Publication
(10) Pub. No.: US 2006/0209034 A1
(43) Pub. Date: Sep. 21, 2006

(54) HAND-HELD ELECTRONIC DEVICE

(76) Inventors: Chia-Hung Chen, Taipei County (TW); I-Hsuan Chen, Taipei City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 11/422,607

(22) Filed: Jun. 7, 2006

Related U.S. Application Data
(63) Continuation-in-part of application No. 10/989,962, filed on Nov. 16, 2004.

(30) Foreign Application Priority Data
Dec. 5, 2003 (TW) 92134470
Feb. 27, 2004 (TW) 93105223

(51) Int. Cl. G09G 5/00

(52) U.S. Cl. 345/169

(57) ABSTRACT

A hand-held electronic device with a plurality of operating functions, comprising a main body, a plurality of number keys disposed on the main body, a display and at least M buttons is provided. The display displays an operation indicator area and a numeral area. The operation indicator area has N operator indicators respectively corresponding to N operators arranged in one or more than one layers along M directions emitted from a reference point. The corresponding operator indicator is indicated by a highlight while one of the operating functions is operated. The numeral area is for displaying the operation value and a result value. Wherein when one of the M operation keys is triggered, the highlight shifts along a corresponding direction to select one of the N operator indicators to perform the corresponding operating function on the operation value. Thereafter the result value is obtained and displayed on the display.

This application claims the benefit of Taiwan applications Serial No. 92134470, Dec. 5, 2003, and Serial No. 93105223, filed Feb. 27 2004, the subject matter of which is incorporated herein by reference.

### BACKGROUND OF THE INVENTION

1. Field of the Invention

The invention relates to a hand-held electronic device, and more particularly to a hand-held electronic device with operating functionality.

2. Description of the Related Art

For traditional desktop calculators, to obtain a calculation result, a user only needs to press functional buttons, except the number keys, up to a maximum of two times. Consecutive calculation of addition, subtraction, multiplying or dividing in one operation only requires the pressing of the corresponding functional button with no need of inserting any equal signs. However, as to mobile phones, due to the limited number of hard keys on the keypad, the process is more complicated to have a specific functional button to be selected.

The common design of the functional buttons can be categorized into several types as listed below

The design of the first type of the functional button is called the Multi-tap selection, wherein it uses one single hard key such as “*” for selecting any operating functions as listed in the following table:

TABLE 1
Multi-tap selection

| | Number of times of pressing the hard key of “*” | | | | |
|---|---|---|---|---|---|
| | | | Three | four | |
| | Once | twice | times | times | . . . |
| Operating function | + | − | × | ÷ | . . . |

However, this method of inputting an operating function (an operator) results in many problems. First of all, a user cannot recognize the operating functions immediately. Second, since a user has to select the operating function by repeatedly pressing a particular button (i.e. hard key), the operating duration will largely depend on the pressing actions and its calculation complexity. The more pressing actions one does, the longer it takes. Thirdly, once any mistake occurs, a user has to spend even more time finding a right one.

The design of the second type of function button is the listed function selection, wherein it uses the left and right buttons to choose the desired operating function, as listed in the table 2:

TABLE 2
Listed function selection

| | Buttons | | | | | | | | |
|---|---|---|---|---|---|---|---|---|---|
| | Left button/right button | | | | | | | | |
| Operating | + | − | × | ÷ | M+ | M− | MR | MC | . . . |
| function | | | | | | | | | |

Apparently, this operational method results in two problems: First, a user has to choose operating function by pressing the left or right buttons. The operating duration will largely depend on the pressing actions and its calculation complexity. Second, consecutive calculation of addition, subtraction, multiplying or dividing in one operation requires repeatedly pressing the left and right buttons to choose the desired operating functions.

### SUMMARY OF THE INVENTION

It is therefore an object of the invention to provide a hand-held electronic device having operation keys disposed on the electronic device and operation indicator area on the display. Therefore, a user can perform the operation by pressing the buttons and simultaneously see the corresponding operator indicators shown on the display. Due to the similar arrangement between the operation keys and the operator indicators, the direction of operation keys pressed is exactly the one the highlight shifting along on the operator indicators. The operator indicators are arranged according to the frequency of the operating function being used. The most common use of the operating functions are set in the inner layer of the operation indicators area, and second common use of the operating functions are set in the outer layer of the operation indicators area. At most two pressing actions are required for a user to perform the corresponding operating functions. Therefore, this design not only fastens the operation, but also decreases the operational mistakes.

In accordance with an object, the invention provides a hand-held electronic device with a plurality of operating functions, comprising a main body, a plurality of number keys disposed on the main body for inputting at least one operation value, a display and at least M buttons. The display is connected to the main body and displays an operation indicator area and a numeral area. The operation indicator area has N operator indicators respectively corresponding to N operators. The N operator indicators are arranged in one or more than one layers along M directions emitted from a reference point. Wherein M and N are both positive integers equal to or greater than 2 and the corresponding operator indicator is indicated by a highlight while one of the operating functions is operated. The numeral area is for displaying the operation value and a result value. The at least M operation keys are disposed on the main body and are respectively corresponding to the M directions. Wherein when one of the M operation keys is triggered, the highlight shifts along a corresponding direction to select one of the N operator indicators to perform the corresponding operating function on the operation value. Thereafter the result value is obtained and displayed on the display.

It is another object of the present invention to provide a method of performing a plurality of operating functions in a hand-held electronic device. The hand-held electronic device comprises a plurality of number keys, a display and M operation keys. The display displays N operator indicators, a highlight, and a numeral area. The N operator indicators are arranged in one or more than one layers along M directions emitted from a reference point. Wherein M, and N both being positive integers equal to or greater than 2, the corresponding operator indicator being indicated by a highlight while one of the operating functions is operated, the M operation keys respectively corresponding to the M directions, and the N operator indicators are respectively corresponding to N operators. The method comprises the following steps. Firstly, at least one operation value is received through the number keys and the at least one operation value is displayed on the display. Second, the highlight is shifted among the operator indicators for selection along at least one corresponding direction to perform at least one operating function corresponding to at least one selected operator indicator while at least one of the M operation keys is triggered. Then the operation function is performed on the operation value corresponding to the selected operator indicator to generate a result value, and the result value is displayed on the display.

In accordance with another object, the invention provides a hand-held electronic device, comprising a main body, a plurality of input keys disposed on the main body, a display connected to the main body and at least one operation key. The display displays an indicator area having at least one indicator being arranged in one or more than one layers along at least one direction emitted from a reference point. The at least one operation key is disposed on the main body and is corresponding to at least one direction. Wherein when a user triggers one of the at least one operation key, a highlight shifts along the corresponding direction for indicator selection.

In accordance with another object, the invention provides an inputting method applied in an electronic device. The electronic device has a plurality of input keys, a display and at least one operating key. The method comprises the following steps. An indicator area is displayed on the display, wherein the indicator area has at least one indicator being arranged in one or more than one layers along at least one direction emitted from a reference point and a highlight for indicating one of the least one indicator. Wherein when one of the at least one operation key is triggered, the highlight shifts along the corresponding direction.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 is a front view illustrating a hand-held electronic device with calculation functionality according to a first embodiment of the present invention.

FIG. 2 is a flow chart illustrating the method of performing calculation functionality with the mobile phone according to the first embodiment of the present invention.

FIG. 3A to FIG. 3D illustrate the first example of performing calculation functionality according to the first embodiment of the present invention.

FIG. 4A to FIG. 4D illustrate the second example of performing calculation functionality according to the first embodiment of the present invention.

FIG. 5A to FIG. 5D illustrate the third example of performing calculation functionality according to the first embodiment of the present invention.

FIG. 6A to FIG. 6D illustrate the fourth example of performing calculation functionality according to the first embodiment of the present invention.

FIG. 7A is a schematic view of the hand-held electronic device in phonetic notation mode according to a second embodiment of the present invention.

FIG. 7B is a schematic view of the hand-held electronic device after inputting two phonetic symbols according to the second embodiment of the present invention.

FIG. 7C shows a sequential arrangement of Chinese characters corresponding to the phonetic symbols.

### DETAILED DESCRIPTION OF THE INVENTION

First Embodiment

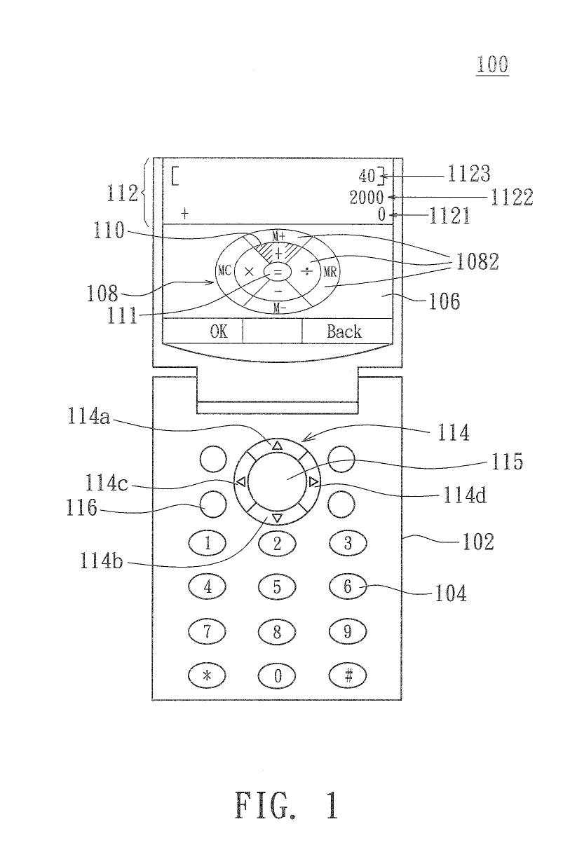

Referring to FIG. 1, a front view of a hand-held electronic device with operating functionality according to the first embodiment of the present invention is illustrated. The hand-held electronic device, example of a mobile phone 100, includes a main body, such as a mobile phone body 102, several number keys 104, a display 106 and at least M operation keys.

The number keys 104 are disposed on the mobile phone body 102. Operation values are inputted through the number keys 104. The display 106 is disposed on the mobile phone body 102. The display 106 at least includes an operation indicators area 108 and a numeral area 112.

The operation indicator area 108 includes a reference point and N operator indicators respectively corresponding to N operators. The N operator indicators are arranged in one or more than one layers along M directions emitted from the reference point. The reference point can be an “equal” sign indicator 111. Moreover, the selected operator indicator is indicated by a highlight 110.

M and N are both positive integers equal to or greater than 2. Preferably, M is equal to 4 and N is equal to 8. The operation indicator area comprises 2 layers and each layer comprises 4 operator indicators 1082 around the equal sign indicator 111. In the following paragraphs, an example of M equals to 4 and N equals to 8 is taken for further description.

The operator indicators 1082 are divided into the first layer and the second layer. The first layer adjacent to the equal sign indicator 111 includes 4 general operator indicators, such as plus sign (+), minus sign (−), multiplying sign (×) and dividing sign (÷). The second layer includes 4 memory operator indicators, including memory operator indicators M+, M−, MC and MR.

Preferably, the plus sign (+) and the memory operator indicator M+ are arranged along an upward direction emitted from the equal sign indicator 111. The minus sign (−) and the memory operator indicator M− are arranged along a downward direction emitted from the equal sign indicator 111. The multiplying sign (×) and the memory operator indicator MC are arranged along a leftward direction emitted from the equal sign indicator 111. The dividing sign (÷) and the memory operator indicator MR are arranged along a rightward direction emitted from the equal sign indicator 111.

The highlight 110 is used to indicate the selected operator indicator 1082. The numeral area 112 is used for displaying the inputted operation value(s) and a result value.

The M operation keys are disposed on the mobile phone main body 102 and respectively correspond to 4 directions of the operator indicators area 108. For example, M is equal to 4, and the 4 operation keys stand for 4 direction keys, upward, downward, leftward and rightward keys 114a, 114b, 114c, and 114d, respectively. When a user presses one of the direction keys, the highlight accordingly moves along one of the upward, downward, leftward and rightward directions to indicate the selected operator indicator. The corresponding operating function of the selected operator indicator 1082 is then performed. Finally, the result value is obtained and displayed on the display.

When one or more of the direction keys are respectively pressed, the highlight 110 accordingly moves along the corresponding directions among the operator indicators 1082 except the equal sign indicator 111. After a single operation, such as +, −, ×, ÷, is completed, the highlight 110 will automatically return to the equal sign indicator 111.

The arrangement and number of the direction keys 114 are substantially identical to those of the operator indicators 1082. For example, the number and arrangement of the general operator indicators “+”, “−”, “×” and “÷” on the first layer of the operator indicators 108 are identical to those of the corresponding direction keys 114a, 114b, 114c and 114d. The number and arrangement of the memory operator indicators M+, M−, MC and MR on the second layer of the operation indicator area 108 are identical to those of the corresponding direction keys 114a, 114b, 114c and 114d.

Furthermore, the direction keys 114 have substantially similar directional relationship with the corresponding operator indicators 1082. For example, the direction key 114d is set at the right side of a central key 115, and the corresponding operator indicators 1082, the general operator indicator “÷” and memory operator indicator MR, are set at the right side of equal sign indicator 111. Users can further understand the operational state with reference to another design shown in FIG. 1. When a general operator indicator is highlighted by the highlight 110, the corresponding operator will be synchronously displayed on the numeral area 112. In FIG. 1, an example of operator indicator “+” is shown for better understanding of the oncoming operation.

Also, by arranging the most commonly-used general operator indicators “+”, “−”, “×” and “÷” on the first layer of the operation indicator area 108, only one pressing action on one of the direction keys 114 is needed to perform the corresponding operating function. The similarity of the arrangements of the direction keys 114 and the operator indicators 1082 enables a user to operate the direction keys 114 and simultaneously see the corresponding indicators 1082. Due to the similarity of directional relationships of the direction keys 114 and the operator indicators 1082, the direction corresponding to the pressed direction key 114 is the one along which the highlight 110 moves on the operator indicators 1082. Therefore, a user can easily perform the calculation without making a mistake.

Besides, a user can check the calculation process by directly looking at the numeral area 112. The numeral area 112 includes the first numeral area 1121, the second numeral area 1122, and the third numeral area 1123. The first numeral area 1121 displays the current value to operate. The second numeral area 1122 displays either the previous value or a result value. The third numeral area 1123 displays a memory value.

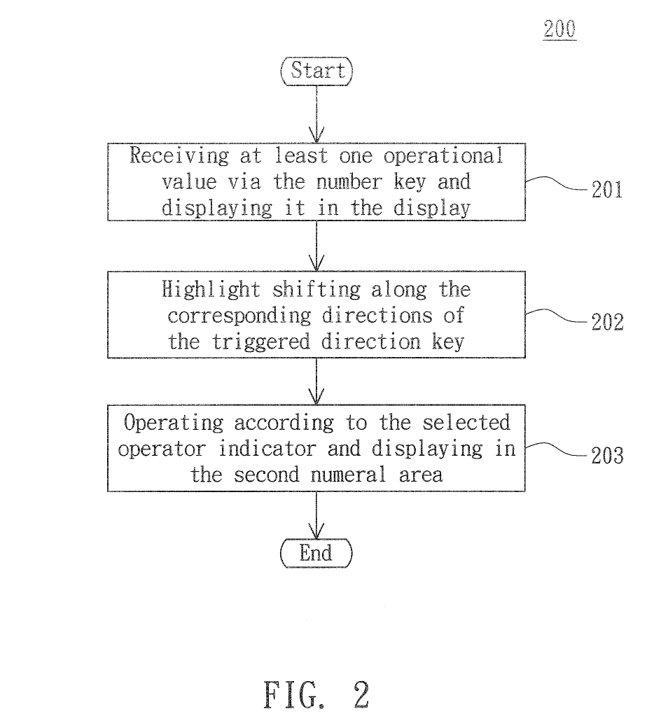

The meanings and functions of the foregoing current value, previous value, result value and memory value are further explained as follows. Referring to FIG. 2, the flow chart of performing several calculation functionality with the mobile phone according to the first embodiment of the present invention is illustrated. Here, M=4 and N=8 are taken as an example for further illustration but the scope of the invention is not limited thereto.

The flow chart 200 according to the invention includes three main steps.

In the first step 201, at least one operation value is inputted into the mobile phone 100 via the number keys 104. The operation value is then displayed on the display 106. For example, the first numeral area 1121 displays at least one current value.

In the second step 202, when one or more of the direction keys 114 is triggered, the highlight 110 shifts along the corresponding directions among the eight operator indicators 1082 for selection.

In the third step 203, the inputted value is operated according to the selected operator indicator 1082. The result value is then displayed on the second numeral area 1122 of the display 106.

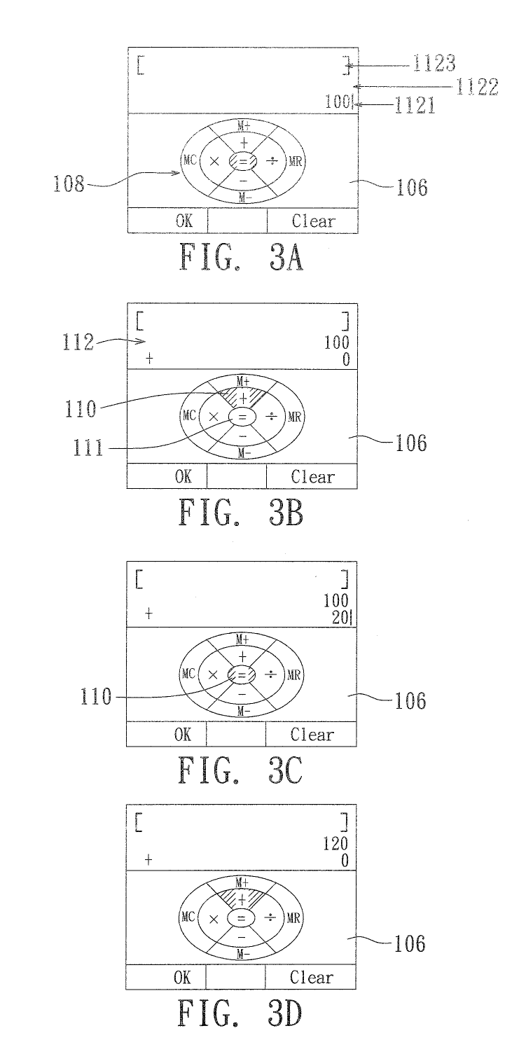

The practical operational flow paths are illustrated in FIG. 3A to FIG. 3D. FIG. 3A to FIG. 3D illustrate the first example of performing calculation functionality according to the first embodiment of the present invention. As shown in FIG. 3A, when inputting a operation value of 100, the operation value of 100 will be a current value to be operated, displayed on the numeral area 1121 of the display 106. When the highlight 110 shifts to the general operator indicator “+”, the current value becomes zero, and the previously inputted operation value of 100 will be displayed on the second numeral area 1122. Moreover, the numeral area 112 will display an operator indicator “+” and the general operator indicator “+” will be highlighted. Next, when inputting the operation value of 20, the operation value of 20 will be displayed on the first numeral area 1121 as a current value, as shown in FIG. 3C. And then, the highlight 110 automatically goes back to the equal sign indicator 111. When the highlight 110 again shifts to general operator indicator “+”, the current value becomes zero again and the second numeral area 1122 displays the result value, the operated value of 120, as shown in FIG. 3C.

There are at least four characteristics in the present invention as follows. First, whenever a operation value is inputted after inserting one of the operators +, −, ×, and ÷, the highlight 110 will automatically return to the equal sign indicator 111 for the convenience of the following operation of addition, subtraction, multiplying, or dividing.

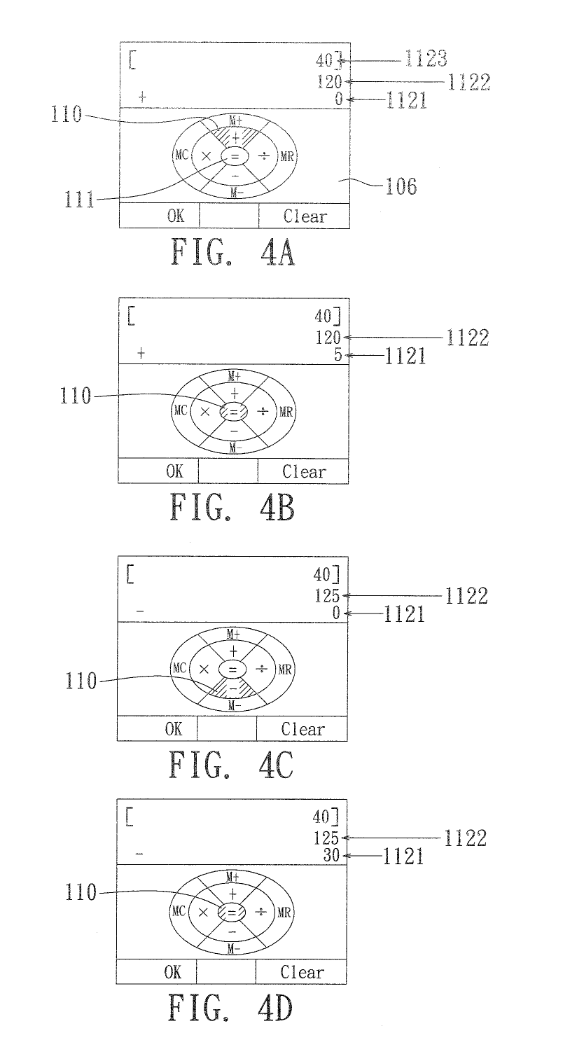

FIG. 4A to FIG. 4D illustrate the second example of performing calculation functionality according to the first embodiment of the present invention. As shown in FIG. 4A, the highlight 110 is on the general operator indicator “+”. The first numeral area 1121 displays the current value of 0, the second numeral area 1122 displays the previous value of 120, and the third numeral area 1123 displays the memory value of 40. When the operation value of 5 is input, as shown in FIG. 4B, the highlight 110 will automatically return to the equal sign indicator 111. Next, when the highlight 110 shifts to the general operator indicator “−”, the current value returns to zero again, and the result value of 125 is displayed on the second numeral area 1122, as shown in FIG. 4C. When inputting the operation value of 30 onto the first numeral area 1121, as shown in FIG. 4D, the highlight 110 will shift back to the equal sign indicator 111 again. In other word, when the highlight 110 is located at one of the general operator indicators and the corresponding operation is performed, the highlight 110 will automatically go back to the equal sign indicator 111.

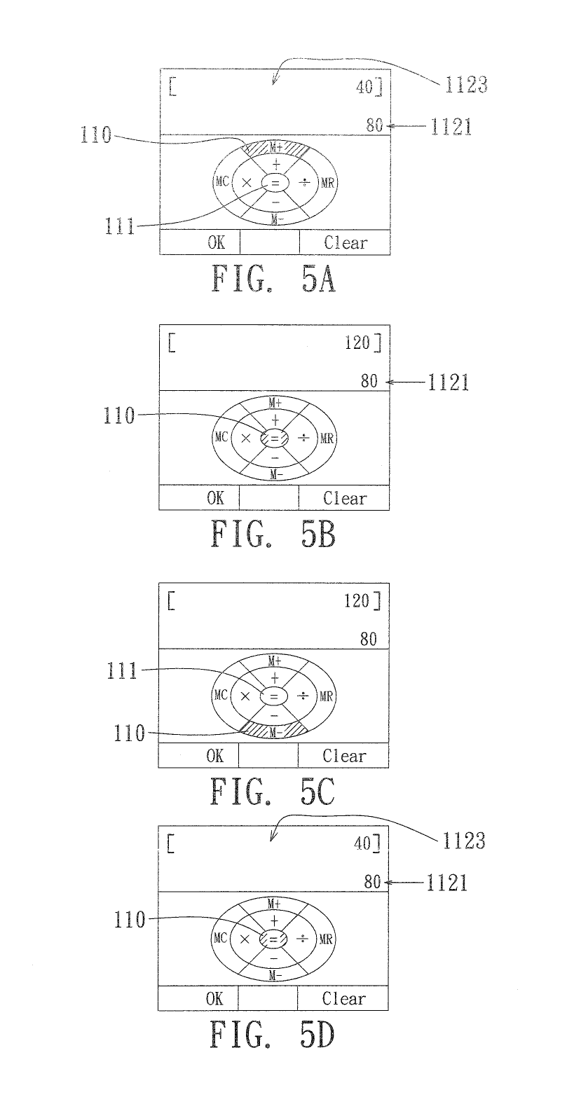

The second characteristic is that after each memory operation, the highlight 110 will automatically return to the equal sign indicator 111 to perform the following operation. Referring to FIG. 5A to FIG. 5D, the third example of performing calculation functionality according to the first embodiment of the present invention is illustrated.

As shown in the FIG. 5A, the highlight 110 shifts to the memory operator indicator M+. Initially, on the display 106, the first numeral area 1121 displays the current value of 80 and the third numeral area 1123 displays the memory value of 40. When the confirmation key 116 (showing in the FIG. 1) is pressed, the memory operation is preformed and the memory value on the third numeral area 1123 is renewed as “120”. The highlight 110 then automatically returns to the equal sign indicator 111, as shown in FIG. 5B. And then, as shown in FIG. 5C, the highlight 110 shifts to the memory operator indicator “M−”. While the confirmation key 116 is pressed, as shown in FIG. 5D, the memory operation is performed again, the memory value on the third numeral area 1123 is renewed as “40” and then the highlight 110 automatically returns to the equal sign indicator 111 again.

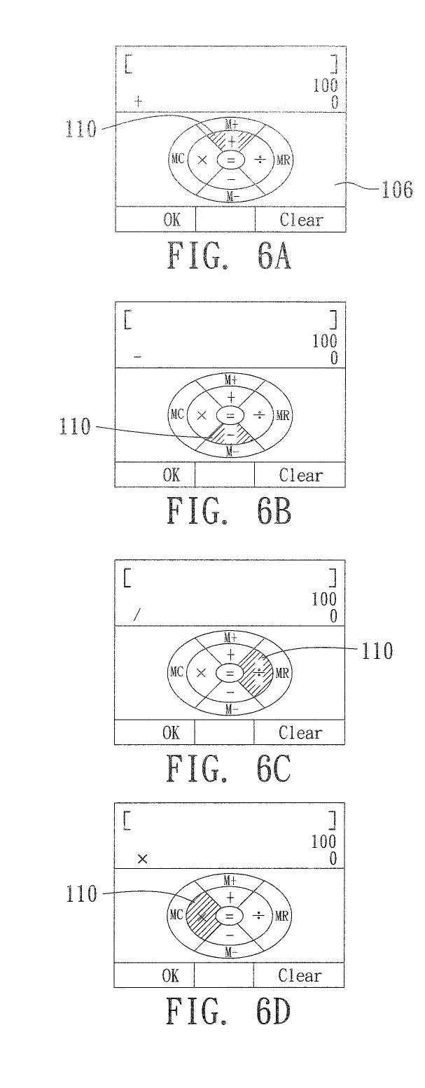

The third characteristic is that when the direction keys 114 are consecutively pressed, the highlight 110 will skip the equal sign indicator 111. Referring to FIG. 6A to FIG. 6D, the fourth example of performing calculation functionality according to the first embodiment of the present invention is illustrated.

When a user consecutively presses the upward, downward, rightward and leftward keys 114a [symbol] 114b [symbol] 114d, and 114c, the highlight 110 will skip the equal sign indicator 111 and allow the general operator indicators “+”, “−”, “÷” and “×” being consecutively highlighted for selection. That is to say, with only one pressing action, the highlight can quickly shift to the desired general operator indicator “+”, “−”, “÷” or “×” to perform the corresponding operation. If one wishes to perform memory operations, merely two pressing actions are needed to quickly shift the highlight to the desired memory operator indicator “M+”, “M−”, “MC” or “MR”.

Furthermore, mis-pressing can be corrected by minimum pressing actions. For example, instead of the desired “M+”, while “+” is mis-pressed, after double pressing the upward key 114a, the highlight 110 will shift to the memory operator indicator “M+”. Hence, it is more convenient for a user to correct the mistake and perform the operation.

The fourth characteristic is the display of the memory values and reducing the complexity of the memory-related operations. The memory-related operations (“M+”, “M−”, “MR”, and “MC”) can be easily performed by two pressing actions to shift the highlight 110 to the corresponding operator indicator. Moreover, the memory values can be displayed on the third numeral area 1123. As a result, the unnecessary operations should be reduced.

Second Embodiment

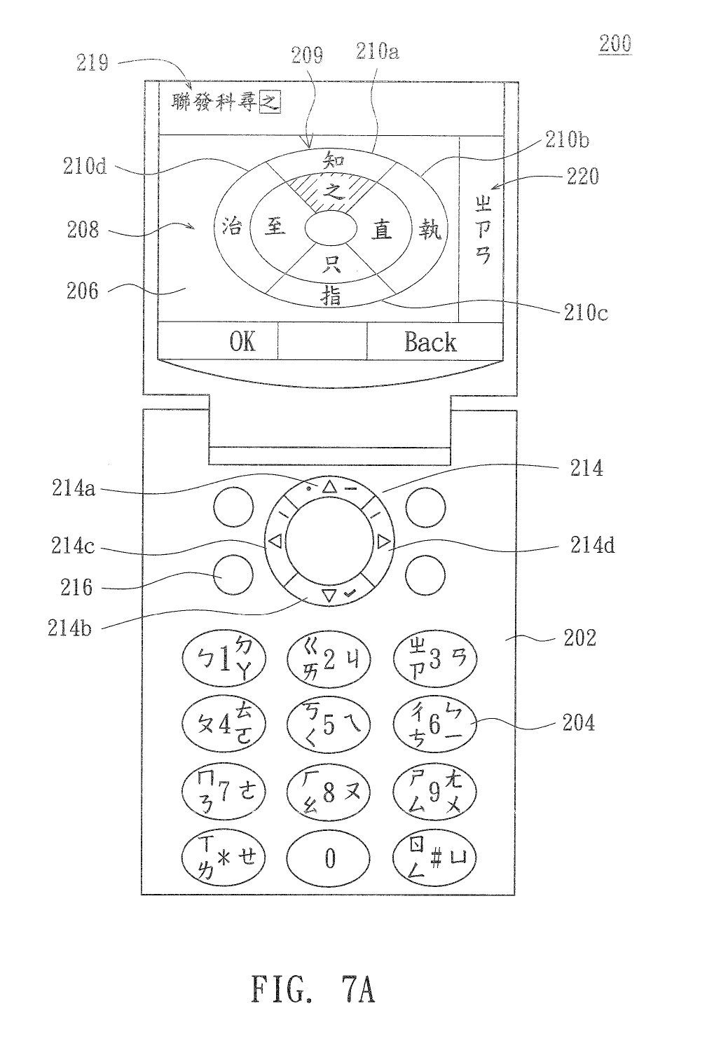

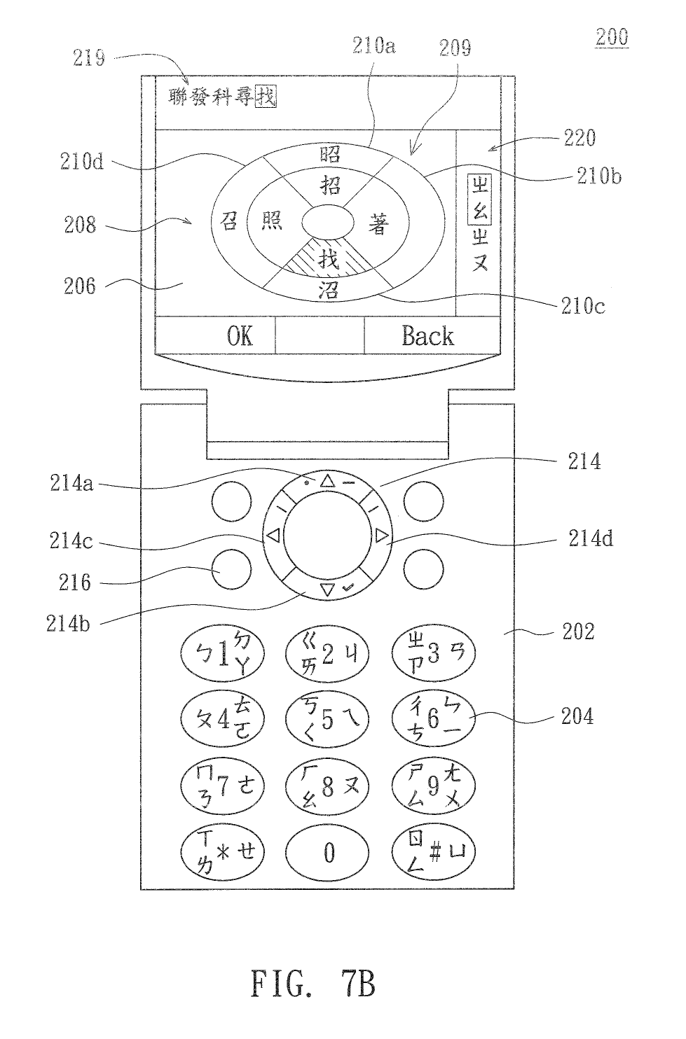

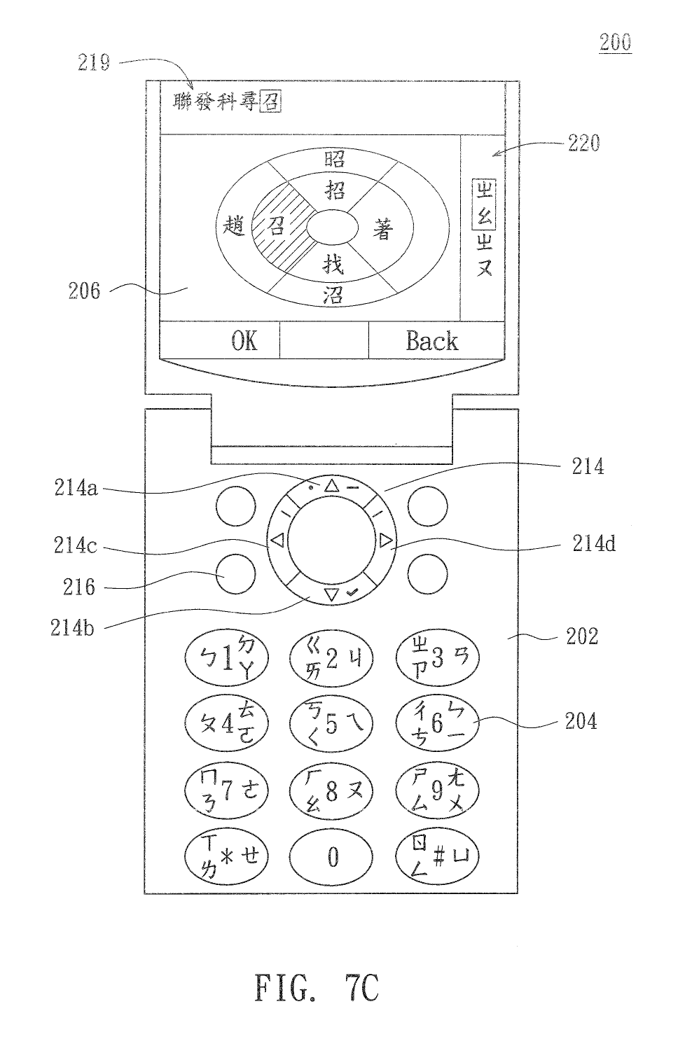

Referring to FIG. 7A, a schematic view of the hand-held electronic device in phonetic notation mode according to a second embodiment of the present invention is shown. In this embodiment, the hand-held electronic device such as a mobile phone 200 includes a mobile phone body 202, several number input keys 204, a display 206 and at least one operation key 214. The input keys 204 are phonetic symbol keys. The following is the way to operate the input keys 204 and operation keys (direction keys) to provide an easier and quick method for inputting Chinese characters. The display 206 has an indicator area 208. The indicator area 208 is divided into a spelling area 220, an inputted area 219 and a character indicator area 209.

Supposing there is a Chinese message needed to be sent by the mobile phone, the message is [symbol] which means “Media Tek recruits new members”. If one user has already inputted four Chinese characters [symbol] the inputted characters would be kept in the inputted area 219. The next character that the user further inputs is the Chinese character [symbol] which has a pronunciation [symbol] (“jao”). Thus first of all, what the user needs to input is the phonetic symbol

[symbol]

Corresponding to the phonetic symbol [symbol] on the mobile phone is the input key with number “3”. However, there are 3 phonetic symbol options on the input key with number “3”. Therefore, when the user presses the input key with number “3”, the three phonetic symbols [symbol] and [symbol] will be shown on the spelling area 220 to offer three options. The user can choose one of the options by pressing the operation keys 214, for example, the upward key 214a and the downward key 214b. While pressing, the characters shown on the indicator area 208 would also change simultaneously in correspondence with the phonetic symbol which is currently highlighted. In the indicator area 208, the characters located in the inner layer are the most frequently used Chinese characters, such as [symbol] and [symbol] which all have pronunciation [symbol] but with four different accents. The Chinese characters [symbol] and [symbol] are pronounced as [symbol] and [symbol] respectively. There are five accents in Chinese character pronunciation, including “^{•}”, [symbol] five accent symbols. The accent symbol [symbol] represents the first accent which is the primitive pronunciation of the phonetic symbol. The accent symbol [symbol] pronounces the second accent. The accent symbol [symbol] pronounces the third accent. And the accent symbol [symbol] pronounces the fourth accent. As for the “^{•}” symbol, which is pronounced shortly is less used in accompany with other phonetic symbols. Hence, the accent symbol “^{•}” can be configured with the accent symbol [symbol] to be operated by the operation key 214a. The accent symbol [symbol] is operated by the operation key 214b. The operation key 214c and 214d controls the accent symbols and

[symbol]

and

[symbol]

respectively.

Therefore, in the inner layer, the Chinese characters [symbol] and

[symbol]

are clockwise arranged in a first accent area 210a, a second accent area 210b, a third accent area 210c and the fourth accent area 210d respectively. In addition, in the character indicator area 209, the outer layer has the characters that are less used than those in the inner layer. For example, the Chinese characters

[symbol]

and

[symbol]

have the same pronunciation but the character

[symbol]

is more frequently used than the Chinese character

[symbol]

Therefore, the Chinese character

[symbol]

is located in the inner layer other than the outer layer. Similarly, the Chinese characters

[symbol]

and

[symbol]

are more frequently used than the Chinese characters

[symbol]

and

[symbol]

Referring to FIG. 7B, a schematic view of the hand-held electronic device after inputting two phonetic symbols according to the second embodiment of the present invention is shown. The Chinese character that the user hopes to input is

[symbol]

The phonetic symbol

[symbol]

is the next symbol to be inputted. The phonetic symbols

[symbol]

and

[symbol]

are all marked on the input key marked with number “8”. But it is only possible for the phonetic symbols

[symbol]

and

[symbol]

to be pronounced with the phonetic symbol

[symbol]

Thus, when a user presses the input key 8, two combinations, including

[symbol]

and

[symbol]

are appeared on the spelling area 220. The user may press the upward key 214a and downward key 214b to control the highlight on the spelling area 220. Meanwhile, the characters on the indicator area 208 can change accordingly. For example, the pronunciations [symbol] and

[symbol]

correspond to the Chinese characters

[symbol]

and

[symbol]

that are more frequently used. As a result of the Chinese character [symbol] corresponding to the third accent 210c, the user may simply press the downward key 214b to highlight the Chinese character [symbol] and then press the confirmation key 216 to finish the input process. Thereafter, the Chinese character

[symbol]

is shown on the inputted area 219. After that, the user can input the next character.

Referring to FIG. 7C, a sequential arrangement of Chinese characters corresponding to the phonetic symbols is shown. In FIG. 7C, if the user presses the leftward key 214c twice, the Chinese character

[symbol]

in the inner layer will not be shown and the Chinese character [symbol] will be highlighted and be shown in the inner layer, while the Chinese character

[symbol]

is shown in the outer layer. That is, if the user desires a rarely used Chinese character with the pronunciation of

[symbol]

the user may continuously press the leftward key 241c several times and the Chinese characters with the pronunciation of

[symbol]

will be shown sequentially. Similarly, other accents can be applied in the same way.

The second embodiment includes several features as follows:

First, while inputting any character in the mobile phone, the inputted characters would be kept on the screen 206. Users can be reminded which character shall be inputted and the length of the sentence. As shown in FIG. 7A, the inputted Chinese characters

[symbol]

are displayed on the display 206.

Second, each time when the user presses one of the input keys, at least four characters corresponding to the four accents

[symbol]

would be shown while the characters corresponding to “^{•}” is disposed on the first accent area with those corresponding to

[symbol]

accent. The characters with different accents shown in the inner layer are the characters that are more frequently used.

Third, the four operation keys (direction keys) respectively correspond to the four accent area, and therefore, the efficiency to choose the desired character can be increased. The user just needs to press the operation key (direction key) for highlighting the desired character corresponding to the specific accent area. In addition, the operation keys can be replaced by a joystick, a roller or the like which can operate the shifting direction of the highlight.

The hand-held device with phonetic notation inputting function disclosed in the second embodiment can speed up the speed to choose different Chinese characters via corresponding the four operation keys to the accents of Chinese characters. The time then can be significantly reduced when a user inputs a message in Chinese.

While the invention has been described by way of example and in terms of embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A hand-held electronic device with a plurality of operating functions, comprising:
a main body;
a plurality of number keys, disposed on the main body, for inputting at least one operation value;
a display, connected to the main body, the display displaying:
an operation indicator area having N operator indicators respectively corresponding to N operators, the N operator indicators being arranged in one or more than one layers along M directions emitted from a reference point, wherein M and N are both positive integers equal to or greater than 2 and the corresponding operator indicator is indicated by a highlight while one of the operating functions is operated; and
a numeral area for displaying the operation value and a result value; and
at least M operation keys, disposed on the main body, respectively corresponding to the M directions, wherein when one of the M operation keys is triggered, the highlight shifts along a corresponding direction to select one of the N operator indicators to perform the corresponding operating function on the operation value, thereafter the result value is obtained and displayed on the display.

2. The hand-held electronic device as claimed in claim 1, wherein the M operation keys are M direction keys.

3. The hand-held electronic device as claimed in claim 1, wherein the highlight automatically returns to the reference point when completing one of the operating functions.

4. The hand-held electronic device as claimed in claim 1, wherein the hand-held electronic device is a mobile phone.

5. A method of performing a plurality of operating functions in a hand-held electronic device, the hand-held electronic device comprising a plurality of number keys, a display and M operation keys, the display displaying N operator indicators, a highlight, and a numeral area, the N operator indicators being arranged in one or more than one layers along M directions emitted from a reference point, wherein M, and N both being positive integers equal to or greater than 2, the corresponding operator indicator being indicated by a highlight while one of the operating functions is operated, the M operation keys respectively corresponding to the M directions, and the N operator indicators respectively corresponding to N operators, the method comprising:
receiving at least one operation value through the number keys and displaying the at least one operation value on the display;
shifting the highlight among the operator indicators for selection along at least one corresponding direction to perform at least one operating function corresponding to at least one selected operator indicator while at least one of the M operation keys is triggered; and
performing the operation function on the operation value corresponding to the selected operator indicator to generate a result value, the result value being displayed on the display.

6. The method as claimed in claim 5, wherein the highlight automatically returns to the reference point when completing one of the operating functions.

7. The method as claimed in claim 5, wherein the M operation keys are M direction keys.

8. The method as claimed in claim 5, wherein the hand-held electronic device is a mobile phone.

9. A hand-held electronic device, comprising:
a main body;
a plurality of input keys, disposed on the main body;
a display, connected to the main body, the display displaying:
an indicator area, having at least one indicator being arranged in one or more than one layers along at least one direction emitted from a reference point; and
at least one operation key, disposed on the main body and corresponding to at least one direction, wherein when a user triggers one of the at least one operation key, a highlight shifts along the corresponding direction for indicator selection.

10. The hand-held electronic device as claimed in claim 9, wherein the input keys are a plurality of number keys for inputting at least one operation value;
wherein the indicator area is an operation indicator area and the at least one indicator is at least one operator indicator, and each of the at least one operator indicator is corresponding to an operator;
wherein the display further comprises a numeral area to display the at least one operation value and a result value; and
wherein when a user selects one of the at least one operator indicator, an operating function corresponding to the operator corresponding to the selected operator indicator is performed on the at least one operation value, and the result value is displayed on the display.

11. The device as claimed in claim 9, wherein the at least one operation key is at least one direction key.

12. The device as claimed in claim 11, wherein each of the at least one operation key is corresponding to one of the at least one direction.

13. The device as claimed in claim 9, wherein the at least one operation key is a roller.

14. The device as claimed in claim 13, wherein the roller has at least one operation direction, each of the at least one operation direction is corresponding to one of the at least one direction;
wherein when the roller is triggered along one of the at least one operation direction, the highlight shifts along the corresponding direction.

15. The device as claimed in claim 9, wherein the operation key is a joystick.

16. The device as claimed in claim 15, wherein the joystick has at least one operation direction, each of the at least one operation direction is corresponding to one of the at least one direction;
wherein when the joystick is triggered along one of the at least one operation direction, the highlight shifts along the corresponding direction.

17. The device as claimed in claim 10, wherein the numeral area comprises a first numeral area for displaying a current value to be operated, a second numeral area for displaying one of a previous value or a result value.

18. The device as claimed in claim 17, wherein the numeral area comprises a third numeral area for displaying a memory value.

19. The device as claimed in claim 9, wherein the highlight automatically returns to the reference point after a specific indicator is selected.

20. The device as claimed in claim 9, wherein the hand-held device is a mobile phone.

21. The device as claimed in claim 9, wherein the input keys are a plurality of phonetic symbol keys for inputting at least one phonetic symbol;
wherein the indicator area is a character indicator area, and the at least one indicator is at least one character indicator, each of the at least one character indicator corresponds to a character;
wherein when one of the at least one character indicator is selected, the character corresponding to the selected character indicator is displayed.

22. The device as claimed in claim 21, wherein each of the at least one character corresponding to the at least one character indicator has an accent, characters with the same accent are aligned in the same direction.

23. An inputting method, applied in an electronic device which has a plurality of input keys, a display and at least one operating key, the method comprising:
displaying an indicator area on the display, wherein the indicator area has at least one indicator being arranged in one or more than one layers along at least one direction emitted from a reference point and a highlight for indicating one of the least one indicator;
wherein when one of the at least one operation key is triggered, the highlight shifts along the corresponding direction.

24. The method as claimed in claim 23, wherein the input keys are a plurality of number keys for inputting at least one operation value;
wherein the indicator area is an operation indicator area and the at least one indicator is at least one operator indicator, and each of the at least one operator indicator is corresponding to an operator;
wherein the display further comprises a numeral area to display the at least one operation value and a result value; and
wherein when one of the at least one operator indicator is selected, an operating function corresponding to the operator corresponding to the selected operator indicator is performed on the at least one operation value, and the result value is displayed on the display.

25. The method as claimed in claim 24, wherein the at least one operation key is at least one direction key.

26. The method as claimed in claim 25, wherein each of the at least one operation key is corresponding to one of the at least one direction.

27. The method as claimed in claim 23, wherein the at least one operation key is a roller.

28. The method as claimed in claim 27, wherein the roller has at least one operation direction, each of the at least one operation direction is corresponding to one of the at least one direction;
wherein when the roller is triggered along one of the at least one operation direction, the highlight shifts along the corresponding direction.

29. The method as claimed in claim 23, wherein the operation key is a joystick.

30. The method as claimed in claim 29, wherein the joystick has at least one operation direction, each of the at least one operation direction is corresponding to one of the at least one direction;
wherein when the joystick is triggered along one of the at least one operation direction, the highlight shifts along the corresponding direction.

31. The method as claimed in claim 24, wherein the numeral area comprises a first numeral area for displaying a current value to be operated, a second numeral area for displaying one of a previous value or a result value.

32. The method as claimed in claim 31, wherein the numeral area comprises a third numeral area for displaying a memory value.

33. The method as claimed in claim 23, wherein the highlight automatically returns to the reference point after a specific indicator is selected.

34. The method as claimed in claim 23, wherein the hand-held device is a mobile phone.

35. The method as claimed in claim 23, wherein the input keys are a plurality of phonetic symbol keys for inputting at least one phonetic symbol;
wherein the indicator area is a character indicator area, and the at least one indicator is at least one character indicator, each of the at least one character indicator corresponds to a character;
wherein when one of the at least one character indicator is selected, the character corresponding to the selected character indicator is displayed.

36. The method as claimed in claim 35, wherein each of the at least one character corresponding to the at least one character indicator has an accent, characters with the same accent are aligned in the same direction.
